(19) United States
(12) Patent Application Publication
(10) Pub. No.: US 2026/0084235 A1
(43) Pub. Date: Mar. 26, 2026

(54) APPARATUS FOR AND METHOD OF ALIGNING A LASER SYSTEM

(71) Applicant: Cymer, LLC, San Diego, CA (US)

(72) Inventors: Michael Smith Duong, Poway, CA (US); Hsing-Yu Chen, Hsinchu City (TW); Nathan Gibson Wells, Escondido, CA (US); Daniel Z Q Wang, Los Angeles, CA (US); Nicholas Anthony Lacroce, Manassas, VA (US); Sang Bin Park, San Diegp, CA (US)

(21) Appl. No.: 18/871,891

(22) PCT Filed: Jul. 14, 2023
(86) PCT No.: PCT/US2023/027783

§ 371 Date: Dec. 5, 2024

Related U.S. Application Data
(60) Provisional application No. 63/390,757, filed on Jul. 20, 2022.
(60) Provisional application No. 63/471,996, filed on Jun. 9, 2023.

(51) Int. Cl. B23K 26/042; G02B 7/00; G02B 27/14

(52) U.S. Cl. CPC B23K 26/042; G02B 7/005; G02B 27/145

(57) ABSTRACT

Disclosed is an apparatus for and method of permitting automatic alignment of optical components in the beam path of a laser. Images of the beam are obtained at one or more positions in the beam path. Alignment and possibly other information is derived from the images and then actuators are controlled to alter the alignment of the optical components in the beam path based on the derived information.

### CROSS-REFERENCE TO RELATED APPLICATIONS

This application claims priority of U.S. application 63/390,757 which was filed on 20 Jul. 2022 and U.S. application 63/471,996 which was filed on 9 Jun. 2023, each of which is incorporated herein in its entirety by reference.

### FIELD

The disclosed subject matter relates to systems in which components of a laser system require alignment as with some components of laser-generated light sources used for carrying out photolithographic integrated circuit manufacturing processes.

### BACKGROUND

Photolithography is a process by which semiconductor circuitry is patterned on a substrate such as a silicon wafer. A photolithography optical source provides the deep ultraviolet (“DUV”) light used to expose a photoresist on the wafer. Often, the optical source is an excimer laser source and the light is a pulsed laser beam. The light beam is passed through a beam delivery unit, a reticle or a mask, and then projected onto a prepared silicon wafer. In this way, a chip design is patterned onto a photoresist that is then developed, etched, and cleaned, and then the process repeats.

In many systems that produce a laser beam (such as a laser generator) or employ a laser beam (such as a photolithography system), there is an optical train that includes one or more optical components (such as mirrors, gratings, prisms, optical switches, filters, etc.) often contained in modules. The laser beam enters the optical train and makes one or more exits after passing through the optical train. Optical components of the optical train may, wholly or partially, reflect, process, filter, modify, focus, expand, etc. the laser beam to obtain one or more desired laser beam outputs.

Optimal laser operation requires that the laser beam be correctly aligned with respect to each optical component of the optical train and/or upon exiting the optical train. Alignment refers to the laser beam intersecting or impacting upon a desired point or points (whether real or virtual in space) after passing through one or more optical components (such as after passing through an optical component or passing through a portion of or the entire optical train).

Aligning the laser is crucial to generating sufficient energy and beam quality for use in a lithography process. Conventionally there are several systems and procedures to align the entire system. There is, however, no system or method that can automatically identify an alignment target or automate physical alignment adjustment.

Improved laser beam alignment and/or laser beam diagnostic apparatuses and methods are subjects of embodiments of the invention herein.

### SUMMARY

The following presents a succinct summary of one or more embodiments in order to provide a basic understanding of the present invention. This summary is not an extensive overview of all contemplated embodiments and is not intended to identify key or critical elements of all embodiments nor delineate the scope of any or all embodiments. Its sole purpose is to present some concepts of one or more embodiments in a streamlined form as a prelude to the more detailed description that is presented later.

According to an aspect of an embodiment there is disclosed an apparatus for and method of permitting automatic alignment of optical components in the beam path of a laser. Images of the beam are obtained at one or more positions in the beam path. Alignment information is derived based on the images and then actuators are controlled to alter the alignment of the optical components in the beam path.

According to another aspect of an embodiment there is disclosed an apparatus for aligning an optical module arranged along a beam path of a beam in a laser light source, the apparatus comprising a beam imager arranged to acquire an image of the beam after the beam has interacted with the optical module, an image analysis module arranged to receive the image and adapted to make an alignment determination of an alignment state of the optical module based at least in part on the image and to generate a control signal based on the alignment determination, and an actuator mechanically coupled to the optical module and arranged to alter the alignment state of the optical module based on the control signal.

The beam path may comprise a power ring amplifier (PRA) alignment path including the optical module. The optical module may comprise at least one of a master oscillator (MO) wavefront engineering box (WEB), a PRA WEB, a PRA chamber, a beam reverser (BR), and an autoshutter module. The optical module may comprise the BR and wherein the image is acquired of the beam at the autoshutter module. The autoshutter module may comprise a combined autoshutter and metrology module.

The image analysis module may be adapted to make the alignment determination based at least in part on detection of at least one edge of an aperture in the optical module. The image analysis module may be adapted to control the actuator to sweep the beam across the aperture to detect at least one edge of the aperture. The image analysis module may be adapted to detect the at least one edge of the aperture using a Hough transform. The image analysis module may be adapted to detect a window and determine a center of the window using an object detecting model. The image analysis module may be adapted to detect the window and determine a center of the window using a Haar Cascade Classifier.

The image analysis module may be adapted to make the alignment determination of the optical module based at least in part on labeling of one or more contours in the image as one of a primary beam and a secondary beam. The image analysis module may be adapted to control the actuator to cause the secondary beam and the primary beam to merge to form a merged beam. The image analysis module may be adapted to control the actuator to increase a symmetry of the merged beam.

According to another aspect of an embodiment there is disclosed a method of aligning an optical modules arranged in a beam path of a beam in a laser light source, the method comprising acquiring an image of the beam after the beam has interacted with the optical module, making an alignment determination of an alignment state of the optical module based at least in part on the image, generating a control signal based on the alignment determination, and using the control signal to control an actuator mechanically coupled to the optical module to alter an alignment state of the optical module.

The beam path may comprise a PRA alignment path. The optical module may comprise one of a MO WEB, a PRA WEB, a PRA chamber, a BR and an autoshutter module in the PRA alignment path. The optical module may comprise the BR and wherein the image is acquired of the beam at the autoshutter module. The autoshutter module may comprise a combined autoshutter and metrology module.

Making an alignment determination of an alignment state of the optical module may comprise detecting at least one edge of an aperture in the optical module.

The method may further comprise controlling the actuator to sweep the beam across the aperture to detect the at least one edge of the aperture. Detecting at least one edge of an aperture in the optical module may comprise using a Hough transform.

Making an alignment determination of an alignment state of the optical module based at least in part on the image may be performed using an image analysis module adapted to detect an aperture or an illuminated surface and determine a center and size of an object using an object detecting model.

The using an image analysis module adapted to detect an aperture or an illuminated surface and determine a center and size of an object an object detecting model may comprise using a Haar Cascade Classifier. Making an alignment determination of an alignment state of the optical module may comprise labeling of one or more contours in the image as one of a primary beam and an ancillary beam.

The method may further comprise controlling the actuator to cause the primary beam and the secondary beam to merge to form a merged beam. The method may further comprise controlling the actuator to increase a symmetry of the merged beam.

According to another aspect of an embodiment there is disclosed an apparatus for aligning an optical module to a beam path of a beam in a laser light source, the apparatus comprising a memory, a beam imager arranged to acquire an image of the beam after the beam has interacted with the optical module, an image analysis module arranged to receive the image, to measure one or more beam characteristics from the image, and to store information indicative of the one or more beam characteristics in the memory, a controller adapted to generate a control signal based on the one or more beam characteristics, and an actuator mechanically coupled to the optical module and arranged to alter an alignment state of the optical module based on the control signal, wherein the image analysis module is further arranged to make a subsequent measurement of the one or more beam characteristics from the image and the controller is arranged to generate the control signal to control the actuator to reduce a difference between the one or more beam characteristics as measured by the subsequent measurement and the stored information.

The beam characteristic may comprise beam skewness, the information indicative of the one or more beam characteristics may comprise a target beam skewness and the image analysis module may be further arranged to make a subsequent measurement of the beam skewness and the controller may be arranged to generate the control signal to control the actuator to reduce a difference between the subsequent measurement of the beam skewness and the target beam skewness.

The beam characteristic may comprise a measured position of a centroid of an image of one of a primary beam component and a secondary beam component of the beam, the information indicative of the one or more beam characteristics may comprise the measured position of the centroid and the image analysis module may be further arranged to make a subsequent measurement of a position of a centroid of the other of the primary beam component and the secondary beam component and the controller may be arranged to generate the control signal to control the actuator to move the position of the centroid of the other of the primary beam component and the secondary beam component to the measured position stored in the memory.

The apparatus may further comprise a beam component blocking element arranged to block the one of the first beam component and the second beam component when the image analysis module is measuring the position of the centroid of the other of the first beam component and the second beam component.

According to another aspect of an embodiment there is disclosed a method of aligning an optical module to a beam path of a beam in a laser light source, the method comprising acquiring an image of the beam after the beam has interacted with the optical module, measuring one or more beam characteristics from the image, storing information indicative of the one or more beam characteristics in a memory, generating a control signal based on the one or more beam characteristics, actuating an actuator mechanically coupled to the optical module and arranged to alter an alignment state of the optical module based on the control signal, making a subsequent measurement of the one or more beam characteristics, and generating the control signal to control the actuator to reduce a difference between the one or more beam characteristics as measured by the subsequent measurement and the stored information.

The beam characteristic may comprise beam skewness, the information indicative of the one or more beam characteristics may comprise a target beam skewness, making a subsequent measurement of the one or more beam characteristics may comprise making a subsequent measurement of the beam skewness, and generating the control signal may comprise generating the control signal to control the actuator to reduce a difference between the subsequent measurement of the beam skewness and the target beam skewness.

The beam characteristic may comprise a measured position of a centroid of an image of one of a primary beam component and a secondary beam component of the beam, the information indicative of the one or more beam characteristics may comprise the measured position of the centroid and making a subsequent measurement of the one or more beam characteristics may comprise making a subsequent measurement of a position of a centroid of the other of the primary beam component and the secondary beam component and generating the control signal to comprises generating the control signal to control the actuator to move the position of the centroid of the other of the primary beam component and the secondary beam component to the measured position stored in the memory.

The method may further comprise blocking the one of the first beam component and the second beam component during measuring the position of the centroid of the other of the first beam component and the second beam component.

According to another aspect of an embodiment there is disclosed an apparatus for aligning an optical module to a beam path of a beam in a laser light source, the apparatus comprising a beam imager arranged to acquire an image of the beam after the beam has interacted with the optical module, an image analysis module arranged to receive the image and to perform a Probabilistic HoughLine Transform to locate a position of one or more features in the image, a controller adapted to generate a control signal based on the one or more features located in the image, and an actuator mechanically coupled to the optical module and arranged to alter an alignment state of the optical module based on the control signal.

The one or more features located in the image may include an illuminated frame in the image.

The one or more features located in the image may include a position of a center of the illuminated frame.

According to another aspect of an embodiment there is disclosed a method of aligning an optical module to a beam path of a beam in a laser light source, the method comprising acquiring an image of the beam after the beam has interacted with the optical module, performing a Probabilistic HoughLine Transform to locate a position of one or more features in the image, generating a control signal based on the one or more features located in the image, and altering an alignment state of the optical module based on the control signal.

The one or more features located in the image may include an illuminated frame in the image.

The one or more features located in the image may include a position of a center of the illuminated frame.

Further embodiments, features, and advantages of the subject matter of the present disclosure, as well as the structure and operation of the various embodiments, are described in detail below with reference to the accompanying drawings.

### BRIEF DESCRIPTION OF THE DRAWING

The accompanying figures of the drawing, which are incorporated herein and form part of the specification, illustrate the present invention and, together with the description, further serve to explain the principles of the present invention and to enable a person skilled in the relevant art(s) to make and use the present invention.

FIG. 1 is a schematic diagram, not to scale, of an overall broad conception of a photolithography system.

FIG. 2 is a schematic diagram, not to scale, of an overall broad conception of an illumination system such as might be used in the photolithography system of FIG. 1.

FIG. 3 is a schematic diagram, not to scale, of a system for alignment of components of an illumination system according to an aspect of an embodiment.

FIG. 4A is a schematic diagram, not to scale, of another system for alignment of components of an illumination system according to an aspect of an embodiment.

FIG. 4B is a schematic diagram, not to scale, of another system for alignment of components of an illumination system according to an aspect of an embodiment.

FIG. 5A is a perspective view, not to scale, of a module for an illumination system according to an aspect of an embodiment.

FIG. 5B is a cutaway plan view of the module of FIG. 5A.

FIGS. 6A and 6B are illustrations of examples of images as might appear in an alignment path according to an aspect of an embodiment.

FIG. 7 is an illustration of an example of an image as might appear in an alignment path according to an aspect of an embodiment.

FIG. 8A is an example of an image as might appear in an alignment path according to an aspect of an embodiment.

FIG. 8B is an example of results of an edge detection process according to an aspect of an embodiment.

FIG. 9 is a flow chart indicating steps in a process for boundary detection according to an aspect of an embodiment.

FIG. 10 is a flow chart for a process for contour labeling and skew adjustment according to an aspect of an embodiment.

FIG. 11 is a flow chart for a process for aperture detection according to an aspect of an embodiment.

FIG. 12 is a functional block diagram, not to scale, of a system for aligning an optical module according to an aspect of an embodiment.

FIG. 13 is a flow chart for part of a process for aligning an optical module according to an aspect of an embodiment.

FIG. 14 is a flow chart for part of a process for aligning an optical module according to an aspect of an embodiment.

FIG. 15A is a representation of an image such as might be acquired according to an aspect of an embodiment.

FIG. 15B is a representation of results of analysis of the image of FIG. 15A according to an aspect of an embodiment.

Further features and advantages of the invention, as well as the structure and operation of various embodiments of the invention, are described in detail below with reference to the accompanying drawings. It is to be noted that the invention is not limited to the specific embodiments described herein. Such embodiments are presented herein for illustrative purposes only. Additional embodiments will be apparent to persons skilled in the relevant art based on the teachings presented herein.

### DETAILED DESCRIPTION

Various embodiments are now described with reference to the drawings, wherein like reference numerals are used to refer to like elements throughout. In the following description, numerous specific details are set forth in order to promote a thorough understanding of one or more embodiments. It may be evident in some or all instances, however, that any embodiment described below can be practiced without adopting the specific design details set forth in connection with that embodiment. In other instances, well-known structures and devices are shown in block diagram form in order to facilitate description of one or more embodiments. This summary is not an extensive overview of all contemplated embodiments and is not intended to identify key or critical elements of all embodiments nor delineate the scope of any or all embodiments.

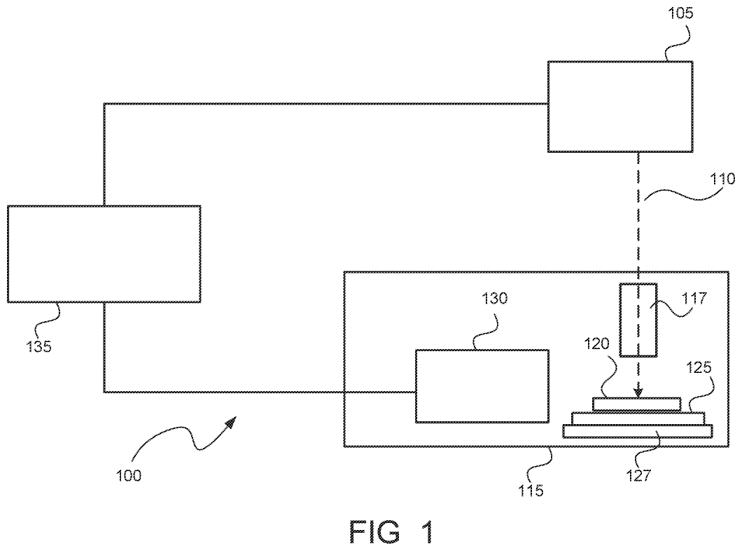

Systems such as those described herein may render benefits in a wide range of applications and implementations. For the sake of having a specific nonlimiting example to facilitate description, one such application is in semiconductor photolithography. FIG. 1 shows a photolithography system 100 that includes an illumination system 105. As described more fully below, the illumination system 105 includes a light source that produces a pulsed light beam 110 and directs it to a photolithography exposure apparatus or scanner 115 that patterns microelectronic and other features on a wafer 120. The wafer 120 is placed on a wafer table 125 constructed to hold wafer 120 and connected to a positioner 127 configured to accurately position the wafer 120 in accordance with certain parameters.

The pulsed light beam 110 may have a wavelength in the DUV range, for example, with a wavelength of 248 nanometers (nm) or 193 nm. The scanner 115 includes an optical arrangement 117 having, for example, one or more condenser lenses, a mask, and an objective arrangement. The mask is movable along one or more directions, such as along an optical axis of the pulsed light beam 110 or in a plane that is perpendicular to the optical axis. The objective arrangement includes a projection lens and enables an image transfer to occur from the mask to photoresist on the wafer 120. The illumination system 105 adjusts the range of angles for the pulsed light beam 110 impinging on the mask. The illumination system 105 also homogenizes (makes uniform) the intensity distribution of the pulsed light beam 110 across the mask.

The scanner 115 can include, among other features, a lithography controller 130 that controls how layers are printed on the wafer 120. The lithography controller 130 may include a memory that stores information such as process recipes that determine the parameters including a length of the exposure on the wafer 120 based on, for example, the mask used, as well as other factors that affect exposure. During lithography, a burst of pulses of the pulsed light beam 110 illuminates the same area of the wafer 120 to constitute an illumination dose.

The photolithography system 100 also preferably includes a control system 135. In general, the control system 135 includes one or more of digital electronic circuitry, computer hardware, firmware, and software. The control system 135 can be centralized or be partially or wholly distributed throughout the photolithography system 100.

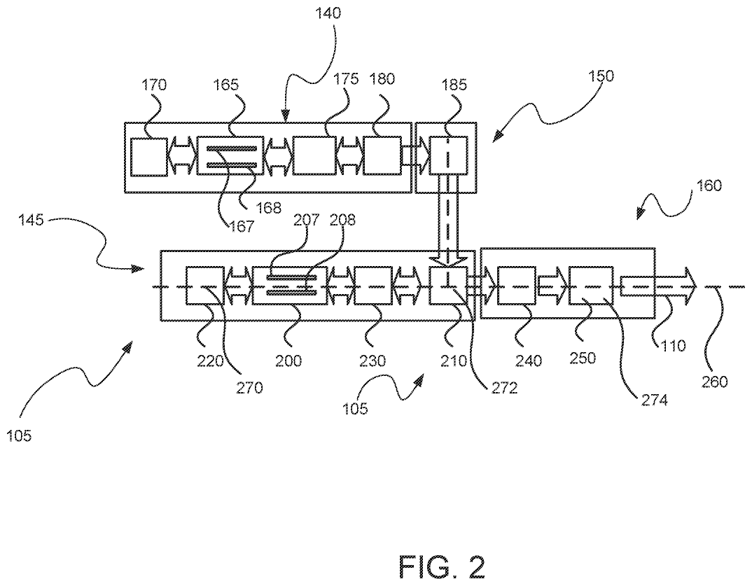

FIG. 2 shows a pulsed laser source that produces a pulsed laser beam as the light beam 110 as an example of an illumination system 105. FIG. 2 shows a two-chamber laser system as a nonlimiting example but it will be understood that the principles explained herein are equally applicable to a single chamber laser system or a laser system having more than two chambers. The gas discharge laser system may include, e.g., a solid state or gas discharge master oscillator (“MO”) seed laser system 140, an amplification stage, e.g., a power ring amplifier (“PRA”) stage 145, relay optics 150 and laser system output subsystem 160. The seed system 140 may include, e.g., an MO chamber 165 which includes a pair of electrodes 167 and 168.

The MO seed laser system 140 may also include a master oscillator output coupler (“MO OC”) 175, which may comprise a partially reflective mirror, forming with a reflective grating (not shown) in a line narrowing module (“LNM”) 170, an oscillator cavity in which the MO seed laser 140 oscillates to form the seed laser output pulse, i.e., forming an MO 165. The MO seed laser system 140 may also include a line-center analysis module (“LAM”) 180. A MO wavefront engineering box (“WEB”) 185 may serve to redirect the output of the MO seed laser system 140 toward the amplification stage 145, and may include, e.g., a multi prism beam expander (not shown) and an optical delay path (not shown).

The amplification stage 145 may include, e.g., a PRA lasing chamber 200, which may also be an oscillator, e.g., formed by seed beam injection and output coupling optics (not shown) that may be incorporated into a PRA WEB 210. The beam may be redirected back through the gain medium in the chamber 200 by a beam reverser (“BR”) 220. The PRA WEB 210 may incorporate a partially reflective input/output coupler (not shown) and a maximally reflective mirror for the nominal operating wavelength (e.g., at around 193 nm for an ArF system) and one or more prisms. The PRA lasing chamber 200 may also include a pair of electrodes 207 and 208.

A bandwidth analysis module (“BAM”) 230 may receive the output laser light beam of pulses from PRA lasing chamber 200 and pick off a portion of the light beam for metrology purposes, e.g., to measure the output bandwidth and pulse energy. The laser output light beam of pulses then passes through the PRA WEB 210 to an optical pulse stretcher (“OPUS”) 240 and an autoshutter, in this case a combined autoshutter metrology module (“CASMM”) 250, which may also be the location of a pulse energy meter. One purpose of the OPUS 240 may be, e.g., to convert a single output laser pulse into a pulse train. Secondary pulses created from the original single output pulse may be delayed with respect to each other. By distributing the original laser pulse energy into a train of secondary pulses, the effective pulse length of the laser can be expanded and at the same time the peak pulse intensity reduced. The OPUS 240 may accordingly be arranged to receive the laser beam from the PRA WEB 210 and direct its output to the CASMM 250.

The PRA lasing chamber 200 and the MO 165 are configured as chambers in which electrical discharges between the electrodes cause lasing gas discharges in a lasing gas to create an inverted population of high energy molecules, including, e.g., Ar, Kr, F₂, and/or Xe, to produce relatively broad band radiation that may be line narrowed to a relatively very narrow bandwidth and center wavelength selected in the LNM 170.

As stated, alignment is the process of adjusting the position, orientation, etc. of these optical components so that the laser beam propagates along a desired beam path. Alignment of modules with respect to the laser beam and the other components may entail adjusting the components making up the module. For example, the alignment of the amplification stage may be determined with respect to a PRA alignment path 260 shown by the broken line in FIG. 2. The PRA alignment path 260 as shown includes the BR 220, the PRA chamber 200, the BAM 230, the PRA WEB 210, the OPUS 240, and the CASMM 250. The PRA alignment path 260 in the example shown also includes the path of the seed laser beam from the MO WEB 185.

Alignment and other beam characteristics are determined by obtaining information about the beam at alignment ports (“AP”s) at various positions in the PRA alignment path 260, referred to herein as imaging the beam. For example, the beam may be imaged at a first position 270 at the BR 220. The beam may also be imaged at a position 272 at the PRA WEB 210 and at a position 274 at the CASMM 250. These images may be near field images or far field images. Beam imaging may include obtaining information about beam/aperture edge detection, beam contours, beam cross sectional structure, positions of relay optics fixtures, and the like.

For the sake of having specific examples to facilitate explanation, the following discussion is in terms of images taken at position 270, far field images taken at position 274, and near field images also taken at position 274. One of ordinary skill in the art will readily appreciate, however, that these are merely examples, and that the teachings supplied herein can also be applied to other images taken at other positions.

In addition, one of ordinary skill will appreciate that the alignment process does not necessarily entail alignment of the optical components most physically proximate to the position in the relay optics at which the image is acquired. For example, the far field image acquired at position 274 may be indicative of the alignment of an optical component several components removed from that position, such as the BR 220.

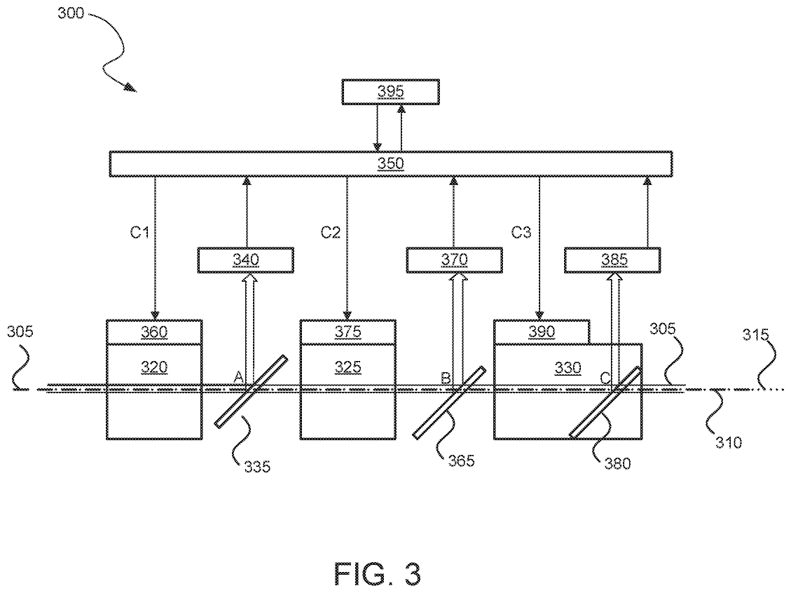

Thus, it would be advantageous if alignment could be performed by an alignment system in which some or all aspects of the alignment processes of imaging, analyzing, and aligning the beam could be automated. FIG. 3 is a diagram of such an alignment system 300. In FIG. 3, a beam 305 propagates along a beam path 310 (dashed line) which optimally coincides with an alignment path 315 (dotted line). The beam path 310 includes relay optics in the form of a first optical module 320, a second optical module 325, and a third optical module 330. These optical modules may respectively correspond to ones of the units BR 220, the PRA chamber 200, the BAM 230, the PRA WEB 210, the OPUS 240, and the CASMM 250 as shown in FIG. 2.

The alignment system 300 also includes an element 335 for deflecting some of the radiation from the beam 305 from a position A into an image capture module 340. The element 335 may be a beam splitter which splits off a small fraction of the radiation from the beam 305. The element 335 may also or alternatively be an element that is movable into or out of the beam path 310 depending on whether a measurement is desired. The image capture module 340 captures an image of the beam at the element 335 (position A) and provides a signal indicative of the results of the capture to a control unit 350. The image capture module 340 may also perform a combination of image analyses such as edge detection, contour detection/labeling, aperture detection, and computer vision/pattern recognition based identification techniques as described in more detail below or these functions may be performed in the control module 350. It will be understood that the functions of the image capture module 340 and the control unit 350 may be combined into one unit or may be distributed between these two units or across more than two units. The control unit 350 generates a control signal C1 which the control unit 350 supplies to an actuator 360. The actuator 360 is coupled to the first optical module 320 and is arranged to change an alignment state of the first optical unit 320 by altering a position, orientation, etc. of an optical component in the first optical unit 340 under control of the control signal C1.

The alignment system 300 also includes an element 365 for deflecting some of the radiation from the beam 305 from a position B into an image capture module 370. The element 365 may again be a beam splitter which splits off a small fraction of the radiation from the beam 305. The element 365 may also or alternatively be an element that is movable into or out of the beam path 310 depending on whether a measurement is desired. The image capture module 370 captures and analyzes an image of the beam at the element 365 (position B) and provides a signal indicative of the results of the analysis to the control unit 350. It will be understood that the functions of the image capture module 370 and the control unit 350 may be combined into one unit or may be distributed across more than two units. The control unit 350 generates a control signal C2 which the control unit 350 supplies to an actuator 375. The actuator 375 is coupled to the second optical module 325 and is arranged to change an alignment state of the second optical module 325 under control of the control signal C2.

The alignment system 300 also includes an element 380 for deflecting some of the radiation from the beam 305 from a position C into an image capture module 385. In the example of FIG. 3, the element 380 is an example of a deflector that is part of an optical module such as the third optical element 330 rather than being positioned between optical modules. The element 380 may again be a beam splitter which splits off a small fraction of the radiation from the beam 305. The image capture module 385 captures and analyzes an image of the beam at the element 380 (position C) and provides a signal indicative of the results of the analysis to the control unit 350. It will be understood that the functions of the image capture module 385 and the control unit 350 may be combined into one unit or may be distributed across both units or more than two units. The control unit 350 generates a control signal C3 which the control unit 350 supplies to an actuator 390. The actuator 390 is coupled to the third optical module 330 and is arranged to change an alignment state of the third optical module 330 under control of the control signal C3.

Again, the control signals C1, C2, and C3 may be generated on the basis of image information that is acquired at a position in the system which is removed from the position at which the image is acquired. For example, the control signal C1 may be based on the image acquired at position C. In other words, the image at position C may be adjusted by altering an alignment state of the optical module 320, that is, by moving (e.g., translating or rotating) an optical component in the optical module 320.

The alignment system 300 also includes a user interface 395 arranged to exchange data with the control unit 350. The user interface 395 and the control unit 350 may be connected by a hard wire connection or wirelessly. The user interface 395 and the control unit 350 may be connected directly or be connected indirectly through intermediary components, ports, busses, etc. The user interface 395 permits a user such as a field service engineer to monitor the automatic alignment process and see the various acquired images of the beam. The user interface 395 also permits a user to override any automatic alignment adjustments as desired.

In general, the user interface 395 may be used to invoke a manual alignment mode that will allow the user to view images and control the actuators. The user interface 395 may also provide the user with the ability to move to different steps in the alignment process. The user interface 395 may provide the user with visual indicators of the current steps in the alignment process, next steps in the alignment process, and errors in the alignment process, as well as view current images. The user interface 395 may permit the user to confirm the results of an automatic alignment process and save alignment images as well as configurations and settings for the image capture modules, actuators, etc.

The actuators 360, 375, and 390 may be through-the-wall adjusters (“TWAs”) that feed through a wall of the enclosure for their respective optical modules 320, 325, and 330. The TWAs may each include an electrically-controlled motor which causes an end of the TWA to translate along its axis according to the direction of rotation of a shaft to alter the alignment of the optical component to which the TWA is coupled. Use of such an electrically-actuated TWA enables automation of the alignment process with the control unit 350 controlling the TWAs to carry out alignment.

The TWA motor may be, for example, a stepper motor or a servo motor. The potential advantages of using stepper motors include that they can generate very high torque at zero speed, they are generally compact and economical, and they can provide holding torque if needed. Servo motors, on the other hand, are able to provide high and consistent levels of torque at high speed. They also normally operate at around 80-90% efficiency and can work with an AC or DC drive although they are larger, more costly, and more complex. In general, one of ordinary skill in the art will appreciate that the choice of whether to use a stepper motor or a servo motor will depend on the demands of a particular application.

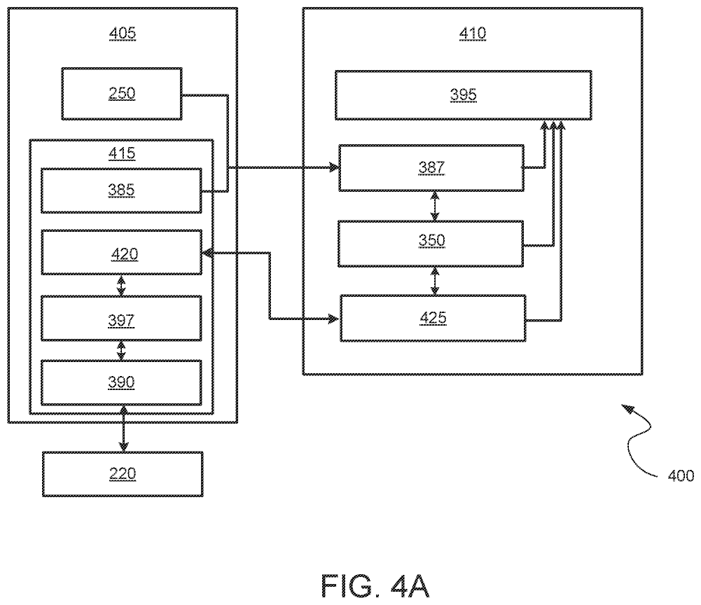

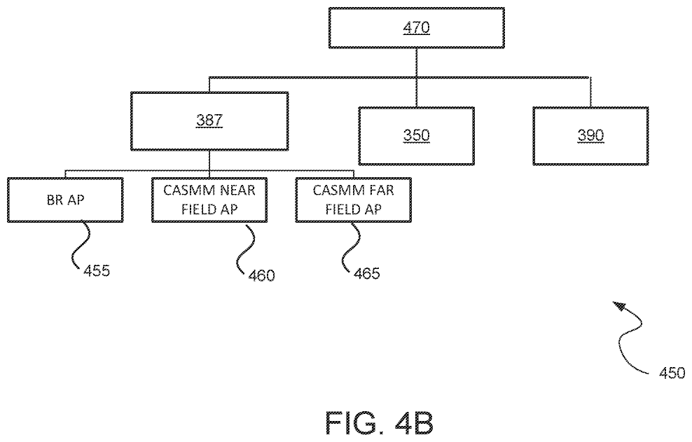

FIG. 4A is a diagram of an alignment system 400 having a different architecture than the alignment system 300. The alignment system 400 of FIG. 4 includes a laser 405 and a computing unit 410. The computing unit 410 may be, for example, a portable computer used by a field service engineer. The laser 405 includes, among all the other modules necessary to produce a laser beam, an optical module which in the example of FIG. 4 is the CASMM 250. The laser 405 also includes a group of relay optics fixtures 415. The relay optics fixtures 415 include an image capture module 385 which may be, for example, a camera. The image capture module 385 communicates image data to an image processing module 387 in the computing unit 410. The relay optics fixtures 415 also include a communication module 420 which handles communications between the laser 405 and the computing unit 410. Communication module 420 is also arranged to communicate with actuator controller software 397 which in turn communicates with the actuator 390. The actuator 390 may be coupled, for example, with the BR 220. Although FIG. 4A shows only one image capture module and only one actuator, one of ordinary skill in the art will readily appreciate that alignment system 400 can be generalized to any number of image capture modules and actuators.

The computing unit 410 also includes the control module 350 and a communication module 425 to interface with the communication module 420 in the laser 405. The computing unit 410 also includes the user interface 395 which may be, for example, a GUI.

In use, the image capture module 385 relays image data to the image processing module 387. The image processing module processes the image data and then provides a signal to the control module 350 indicative of an alignment error. The control module 350 then communicates through the communication modules 425 and 420 with actuator controller software 397 which then controls the actuator 390, which may be a stepper motor, to alter the alignment of the CASMM 250. At the same time, information from the image processing module 387, the control module 350, and the communication module 425 is provided to the user interface 395.

FIG. 4B shows another possible arrangement 450 of alignment system. In the example of FIG. 4B the alignment system captures images at the BR AP 455, the CASMM nearfield AP 460 and the CASMM far field AP 465. Images of these alignment ports are captured by the image processing module 387. Information from the image processing module 387 is passed to the control unit 350. The control unit 350 generates a control signal which controls an actuator 390. The entire process is controlled by a GUI/controller 470.

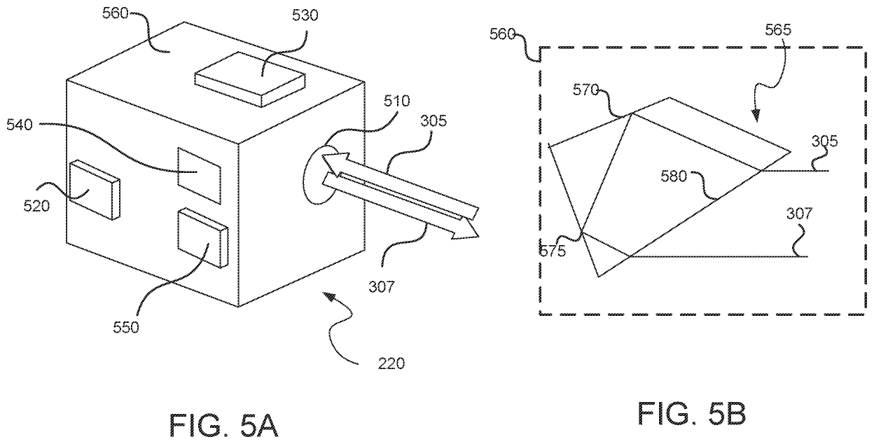

FIG. 5A shows an example of an optical module such as could be used in the alignment system of FIG. 3, FIG. 4A, or FIG. 4B. The example of an optical module in FIG. 5A is the BR 220. As can be seen, the BR 220 has an enclosure 560 and an aperture 510 through which the beams 305 and 307 pass. The BR 220 also includes a TWA 520 for aligning a horizontal position of an optical component inside the BR 220, in this case a prism 560 as shown in FIG. 5B, and a TWA 530 for aligning a vertical position of the prism 560 in the BR 220. Also shown is a TWA 550 for adjusting an alignment tool prism to make an image of the beam 305 available at a BR port 540. Each of the TWAs includes an actuator (e.g., stepper or servo motor) that moves the through the wall adjuster in response to a control signal as mentioned above.

As shown in FIG. 5B, the prism 565 may incorporate two totally internal reflecting surfaces 570, 575 and an input face 580. These and other details concerning possible implementations of a beam reverser are available from U.S. Pat. No. 7,885,309, issued Feb. 8, 2011, and titled “Laser System.” All patent applications, patents, and printed publications cited herein are incorporated herein by reference in their entireties, except for any definitions, subject matter disclaimers or disavowals, and except to the extent that the incorporated material is inconsistent with the express disclosure herein, in which case the language in this disclosure controls.

Again using the example of an alignment procedure involving the BR 220 image and the CASMM 250 near field image and the CASMM 250 far field images these images may be acquired by looking at AP images. Thus, in this example, position 270 (FIG. 2) may be referred to as AP 270. AP 270 is located at the BR 220, and the image there is acquired by placing a camera at the BR alignment port, i.e., AP 270. The CASMM 250 near and far field images are located at the CASMM 250 or at an autoshutter module in systems that have an autoshutter module rather than a CASMM. The CASMM 250 will typically already include a camera for acquiring images there. If an autoshutter is used then it will typically have an alignment port on which a camera may be mounted.

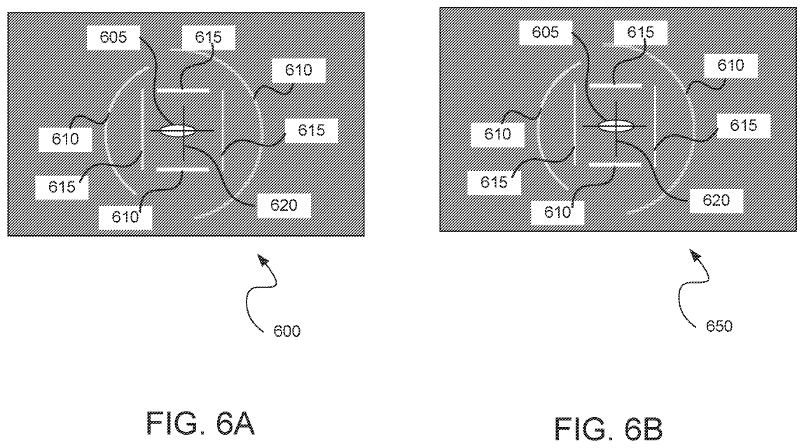

As shown in FIG. 6A, typically an unaligned beam will produce an image such as image 600 which will include an image of the beam 605 and of any illuminated fixtures such as edges 610 of windows. In the figure, the inner “box” or aperture 615 needs to be characterized in order to find its center, which will serve as the center target position. Identifying the beam's center is also required in order determine the beam's position within the aperture. Moving the beam's center to the center of the aperture to get the image 650 as shown in FIG. 6B is desired to obtain alignment. Generally speaking, the cross hairs 620 are not illuminated and not available for centering the beam.

One method of finding the proper aperture size and position for establishing a centering target position involves the use of an object detecting model pre-trained to recognize features of interest. Any one of a number of object detecting models could be used. In the example that follows a Haar Cascade Classifier is used as an example of the use of an object detecting model to identify boundary boxes, such as the aperture edges, that will be used to establish a target. Haar Cascade classifiers are described in Viola, P. and Jones, M., 2001, December. “Rapid object detection using a boosted cascade of simple features” in Proceedings of the 2001 IEEE Computer Society Conference on Computer Vision and Pattern Recognition. CVPR 2001 (Vol. 1, pp. I-9). Once the model is properly trained it can be used for alignment.

In general, the model can be trained by capturing alignment port images and then executing image augmentation on captured images to increase the number of sample images. The images are then labeled and then the training procedure of the applied object detecting model is used on the labeled images.

This process can automatically determine and identify positions of several key features within the image, such as an alignment target, illuminated window edges, or discernible reference locations to be used later. Additionally, potential false positive results can be adjusted to ensure that a detected window size is proper using known window dimensions. In other words, a result may be discarded if it does not fall within the range of possible dimensions. Using the information gained from the image processing, the procedure can provide recommendations and directions that will be used for controlling the actuators to move the beam towards the target, thus aligning the image.

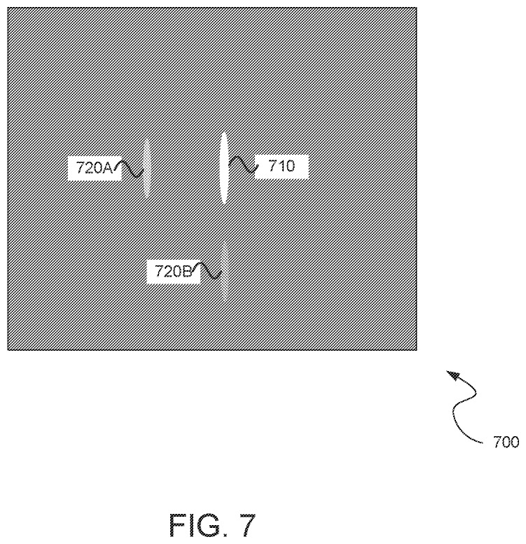

FIG. 7 shows another example of a beam image. Beam image 700 in FIG. 7 is an example of a far field image as might be acquired at the alignment port of the CASMM 250 (position 274 in FIG. 2). The image 700 includes a MOPA seed beam 710 and two ancillary or secondary “daughter” beams 720A and 720B. The alignment goal for an image such as image 700 may be to converge the daughter beams 720A, 720B into the MOPA beam 710 while minimizing divergences and maximizing PRA energy. This process may involve detecting which of the beams is the MO seed beam and which is the MOPA beam propagating along the PRA beam path using, for example, pixel skewing, where a left and right skew can be used as a metric indicator to align and overlap the beams by minimizing the slew factor.

In other words, the image 700 is ideally of a single centralized, symmetric beam. When the image is out of alignment, several visual beams (MOPA and daughter beams) are visible. There can be up to five potential beams in the image at one time. It is necessary as part of the alignment process to identify, i.e., label the MOPA and daughter beams and choose the proper daughter beam to track when adjusting. The alignment procedure in general focuses attention on the MOPA beam and the third beam when five beams are detected or the dimmer beam if two beams are observed.

In the image shown in FIG. 7, the beam of interest is the dimmest visual beam image, i.e., daughter beam 720B. This beam will be used by the alignment system to adjust the module to merge the beams into one beam. Once there is a single consolidated beam, an additional process may be undertaken to make the beam symmetric along the x and y axes.

According to one aspect of an embodiment, computer vision techniques are used for determining and labeling beams such as those shown in the image 700 including the MOPA seed beam 710 and the daughter beams 720A, 720B. As described in more detail below, these techniques may include image preprocessing, determining all contours or shapes within an image, utilizing the features of daughter (secondary) beams to determine their validity, and logic to provide the proper ordering and labeling of each valid contour or secondary beam.

Automatic contour labeling determines how and where to move the secondary beam of interest. Once the alignment system determines that a single contour has been achieved, it calculates skew, a measure of symmetry, on the pixel summations in both the vertical and horizontal directions of the contour. This measurement determines the direction to move the secondary beam in order to reduce skew and obtain a more symmetric target beam.

Thus, according to another aspect of an embodiment, the alignment system can sequentially sort through valid contours and provide labels for all shapes found on the image. One benefit of this sorting capability is that the system can hone in onto the secondary beam of interest and move the actuators to adjust the secondary beam of interest's position to be more in line with the target beam so that there is only a single contour present. When the system makes such a determination, it can then perform an additional adjustment metric (skew) causing the beam to become more symmetric.

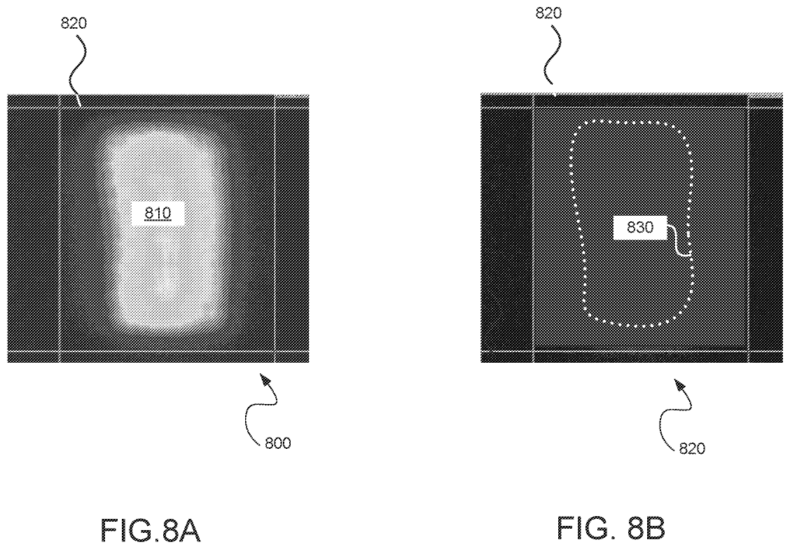

FIG. 8A is an example of a near field image 800 of a combined MO seed beam and PRA beam. The MO seed beam does not “fill” the entire aperture profile indicated by the “box” lines in FIGS. 8A and 8B which are added manually. This may cause an issue when aligning to the center aperture boundaries because the aperture profile is not visible in the image of FIG. 8A which is available to the system. Without determining the proper aperture boundaries, the alignment system would be unable to determine the center of the aperture that can be used for alignment. Moving the beam's center to the center of the aperture is desired to obtain proper alignment.

According to an aspect of an embodiment, line detection, logic, and sequential searching are used to move the beam to detect and retain the near field aperture boundaries. FIG. 8B shows the results of a boundary detection. Once the system detects the aperture edges, it can retain these values and establish the position of a center of the aperture that is used to align the system. The beam can be moved automatically around the aperture edges. Additionally, the center of the contour (visual image-processed beam outline) can be retained and used to calculate an alignment error.

In more detail, beam image 800 in FIG. 8A is an example of a near field image as might be acquired at the CASMM 250 (position 274 in FIG. 2). The image 800 includes an image of the MO seed beam 810 and a box trace 820 indicating the aligned position of a non-illuminated aperture at position 274. The alignment goal for an image such as image 800 may be to find the edges of the non-illuminated aperture and center the MO Seed beam 810 on the aperture. This may involve the use of edge detection to identify the edges 830 of the MO seed beam 810 in the image 820 as shown in FIG. 8B.

One method of edge detection may be to use a feature extraction technique known in the art of image analysis such as a Hough transform, e.g., a Standard Hough Transform or a Probabilistic Hough Transform, to detect edges. Other methods of edge detection may be used such as an integral transform, e.g., a Radon Transform, or pixel brightness transitions. Other techniques known in the fields of image analysis may also be used. It is also possible to use an open loop solution to determine the aperture location by controlling the related actuator to sweep the beam across the aperture and using a bright spot summation to determine the location of the aperture edge. Edge detection is used in a feedback loop to cause the actuator to stop sweeping in the then-current direction and to start sweeping along a new path to find the other edges of the aperture. After the aperture is located, the alignment system can determine a determined pixel error between the location of the beam centroid and the aperture center.

As mentioned, part of the image analysis may involve locating the position of an unilluminated (dark) crosshair target or frame. One measure to improve overall determination of beam alignment may be to position the beam so it is near the center of the target and then use additional image processing to detect the position of the dark target and recalibrate to the exact target center. Another possibility is to use an external fixture light source to illuminate the target from the module access port with the beam not firing.

One of ordinary skill in the art will appreciate that the alignment process may be iterative in the sense that a first element may be aligned (such as a folding mirror in the PRA WEB), then a second element may be aligned (such as a folding mirror in the MO WEB), and then the first element may then a require additional alignment because a shift in the second element alignment may also cause a shift in the alignment of the first element alignment and vice versa. The process converges to an optimum alignment being achieved with repeated iterations.

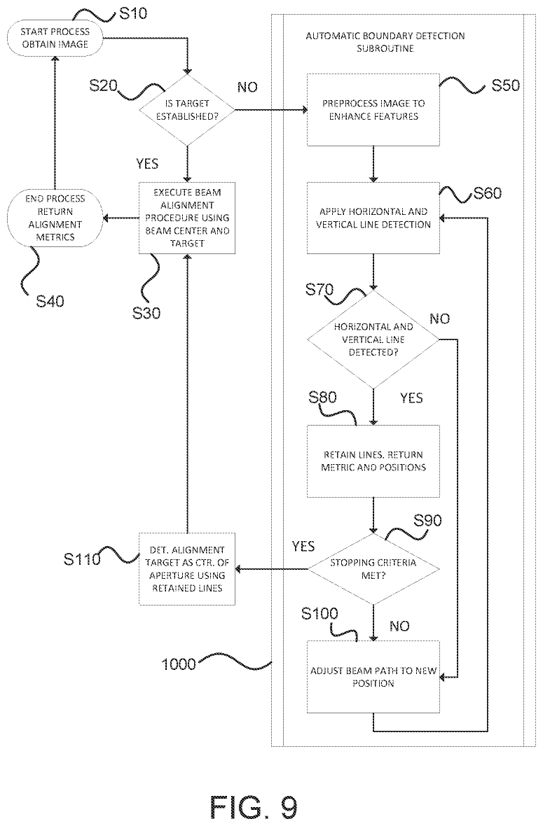

FIG. 9 is a flow chart showing a process for boundary detection according to an aspect of an embodiment. The process starts at a step S10 in which an image is obtained. Then, in a step S20, it is determined whether the position of the target (e.g., cross hairs, aperture edge) has been established. If the position of the target has been established, then in a step S30, beam alignment is executed using the established beam center and target and then the process ends at a step S40 where the process may return alignment metrics indicating alignment status and parameters.

If, however, in step S20 it is determined that the target has not been established, then the process reverts to an automatic boundary detection subroutine 1000. In a step S50 of the automatic boundary detection subroutine, the image is preprocessed to enhance features. Such preprocessing may include, for example, enhancing contrast. Then, in a step S60, horizontal and vertical line detection techniques are applied, and, in a step S70 it is determined whether the detection techniques have actually detected a horizontal and vertical line.

If the determination in step S70 is negative then the process goes to a step S100 in which the beam path is adjusted to a new position and then returns to execution of step S60. If, however, a horizontal and vertical line are detected, then the lines are retained and their positions are returned. In a step S90 it is determined whether the stopping criteria have been met. If the stopping criteria have been met, then the subroutine 1000 terminates and in a step S110 the alignment target is determined as the center of an aperture using the retained lines. If it is determined in step S90, however, that the stopping criteria have not been met, then the process again passes to step S100 where the beam path is adjusted to a new position and then the process reverts to step S60.

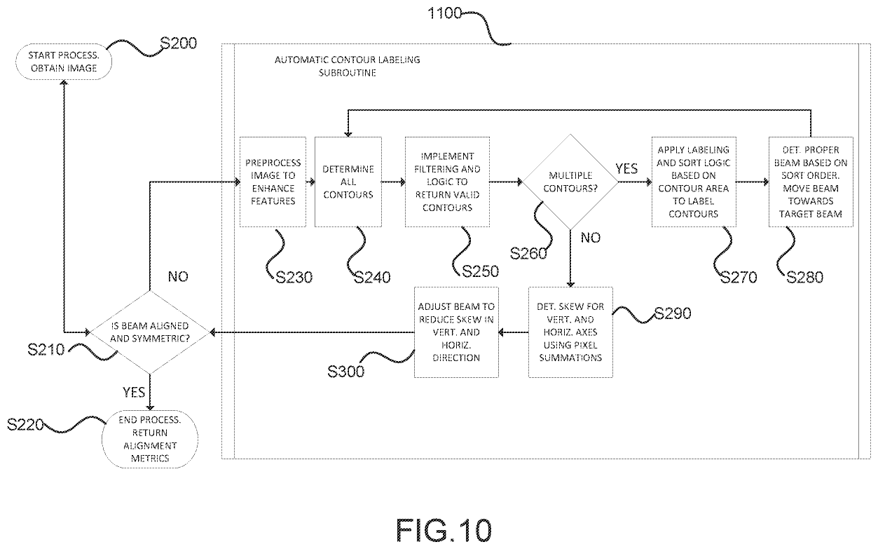

FIG. 10 is a flow chart for a process for contour labeling (and skew adjustment) according to an aspect of an embodiment in which contour labeling may be used to align one or more secondary beams to a primary beam. The process starts at a step S200 in which an image is acquired. Then, in a step S210, it is determined from the acquired beam image whether the beam is aligned and symmetric. If the beam is aligned and symmetric, then the process ends at a step S220 where the process may return alignment metrics indicating alignment status and parameters.

If, however, in step S210 it is determined that the beam is not aligned and symmetric, then the process of FIG. 10 invokes an automatic contour labeling subroutine 1100. In a step S230 of the automatic boundary contour labeling subroutine 1100, the image is preprocessed to enhance features. Such preprocessing may include, for example, enhancing contrast. Then, in a step S240, all contours in the image are determined. Then in a step S250, filtering and logic are used to identify which of the contours that have been determined are valid, i.e., can be associated with a beam.

In a step S260 it is determined whether multiple contours have been identified. If yes then in a step 270 labeling is applied and sorting logic is used based on contour area to label the contours with the appropriate label for the beam they represent, e.g., MOPA or daughter beam. Then, in a step 280, the proper beam for tracking (of any daughter beams) is determined based on the sort order and the daughter beam is moved towards the MOPA beam to produce a single, merged beam. Then the process reverts to step 240.

If, however, in the step S260 multiple contours are not determined, then contour labeling is deemed complete and then an additional process is carrying out for determining a skew of the merged beam for the vertical and horizontal axes using pixel summations. Then in a step S300, the beam is adjusted to reduce skew in the vertical and horizontal direction. Then the automatic counter labeling subroutine terminates and it is determined in step S210 if the beam is aligned and symmetric. If it is determined in step S210 that the beam is still not aligned and symmetric, then the process reverts to step S230. If, on the other hand, is determined in step S210 that the beam is aligned and symmetric, then the process ends in a step 220 and the alignment metrics are returned.

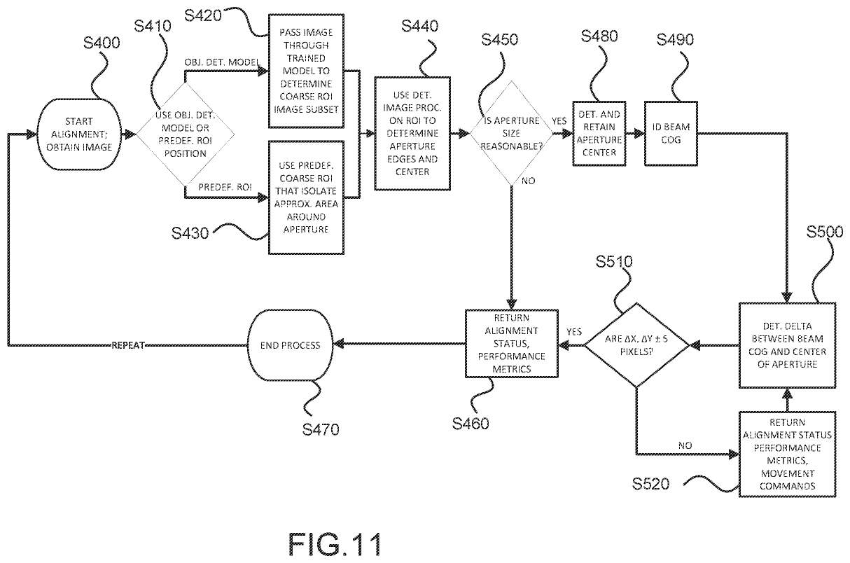

FIG. 11 is a flow chart showing an example of a procedure including detecting an aperture edge and center in accordance with an aspect of an embodiment. The process starts in a step S400 with obtaining an image. The image may be, for example, an alignment port image.

In a step S410 it is determined whether use an object detecting model or a predefined coarse region of interest (ROI) position.

If it is determined in step S410 that an object detecting model is to be used, then in a step S420 the image is passed through an object detecting model to determine a coarse ROI subset in the image. If instead in step S410 it is determined to use a predefined ROI position, then in a step S430 the predefined coarse ROI is used to isolate the approximate area around the aperture.

Then, regardless of which of steps S420 or S430 is used, deterministic image processing is used in step S440 on the coarse ROI image subset (step S420) or the approximated area around the aperture (step S430) to determine the aperture edges and the center of the aperture. Then, in a step S450, it is determined whether the inner dimension of the aperture as determined is “reasonable,” that is, whether the determined inner dimension corresponds to a known aperture dimension. If in step S450 is determined that the determined aperture size is not reasonable, then in a step S460 the alignment status and performance metrics are returned. The process then ends at a step S470 and then repeated by looping back to the starting step S400.

If, however, it is instead determined in step S450 that the determined aperture size is reasonable then in a step S480 the position of the center of the aperture is determined and retained. Then in a step S490 the center of gravity (“COG”) of the beam is identified.

Next, in a step S500, a distance and direction (delta) are determined between the COG of the beam and the determined center of the aperture. Then in a step S510 it is determined whether the distance in an x-dimension (Δx) and the distance in the y-dimension (Δy) between the aperture center and the beam COG are within a prescribed limit (for example, five pixels). If either Δx or Δy or both exceed their respective prescribed limit, then in a step S520 the alignment status, performance metrics, and movement commands (actuator control signals) are returned and the process then reverts to step S500. If, however, is determined that neither Ax nor Ay exceeds its respective prescribed limit, then the process proceeds to step S460 and is then ended in step S470 to be repeated starting again with step S400.

The steps of the process may be performed in various orders. Not every alignment process will use all of the steps and methods outlined above. Several of the steps may be iterative, i.e., repeated a number of times in succession to converge on a desired alignment. A later alignment step may necessitate repeating an earlier alignment step. A specific example of an overall alignment procedure may start with using the MO Seed Beam at the CASMM to find aperture boundaries, scanning for the boundaries by using the MO WEB TWA and identifying the boundaries using Hough line edge detection, and then centering the MO Seed Beam to the identified boundary's center. Next may be several iterations of manipulation of the MO WEB TWA to place the MO seed beam at the previously identified CASMM aperture center and of the PRA WEB TWA to center the beam on the BR alignment port crosshair.

At some point the PRA OC may be aligned, then deliberately de-aligned. The BR TWA would then be manipulated to center the MO seed beam in the previous identified CASMM aperture center. Then the PRA chamber could be aligned. Then the PRA OC could be re-aligned with contour detection and with the beam being rendered more symmetric by reducing its skewness.

Several iterations and combinations of iterations of the above steps may be carried out and/or additional sub-steps may be performed.

As mentioned, according to an embodiment, the image analysis module may be used to determine the alignment state of an optical module by acquiring an image of the beam at or optically downstream of the optical module and labeling one or more contours in the image as either a primary beam component or a secondary beam component. The image analysis module may then control the actuator to cause the secondary beam component and the primary beam component to merge to form a merged beam. The image analysis module may be adapted to control the actuator to increase a symmetry of the merged beam. For example, the image analysis module may control the actuator to increase a horizontal (left-right) symmetry, a vertical (up-down) symmetry, or both.

There may be instances in which the primary beam component may exhibit a high degree of asymmetry. In such instances, according to an embodiment, the system may store a current skew value (a measure of symmetry) of the beam image, e.g., a far field image of the beam, in memory as a target skew value. Then, subsequently, during a process of merging a primary beam component with a secondary beam component, the system may target the skew value stored in memory to make the symmetry of the merged beam as close as possible to the symmetry of the previous merged beam for which the skew value was stored.

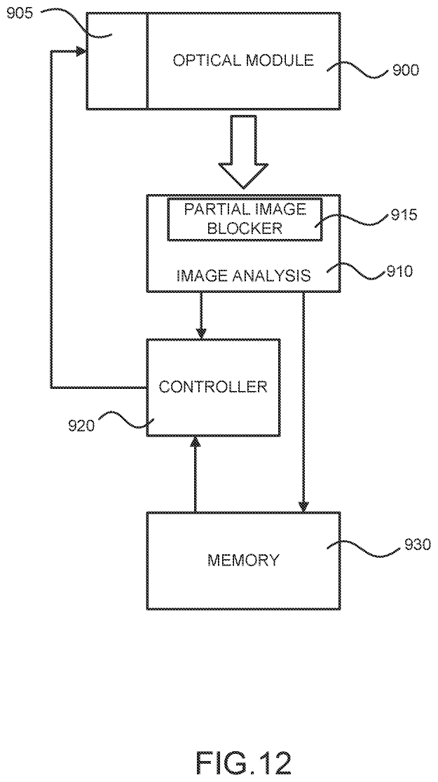

A system for carrying out this procedure is shown in FIG. 12. As shown, an optical module 900 presents a beam image (indicated by the arrow) to an image analysis module 910. The image analysis module 910 measures a value for a characteristic of the image, in this example, its skewness. The image analysis module 910 supplies the measured skewness value to a controller 920 that controls an actuator 905 to bring the optical module 900 into proper alignment. The image analysis module 910 also stores the measured skewness value in a memory 930 as a target skewness value. Then, in a subsequent measurement while merging the primary beam component and the secondary beam component, the image analysis module 910 measures a current skewness value, i.e., a skewness value obtained during the subsequent measurement, and sends the current skewness value to the controller 920. The controller 920 also accesses the target skewness value stored in the memory 930 and controls the actuator to reduce a difference between the current skewness value and the target skewness value. In some embodiments the controller 920 controls the actuator to make the current skewness value substantially equal to the target skewness value.

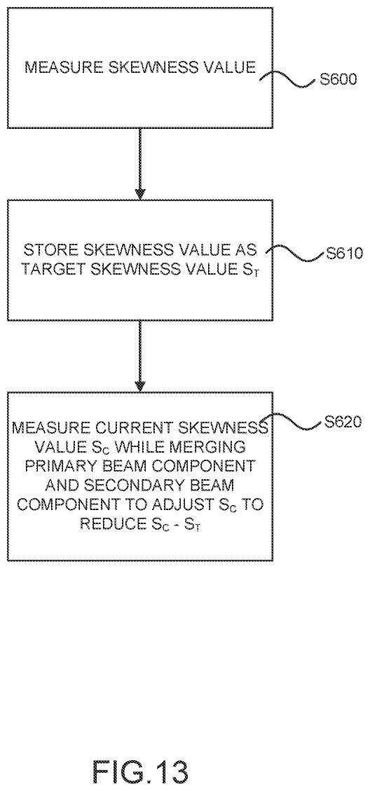

FIG. 13 is a flow chart describing this procedure. A skewness value is measured from a beam image from an optical module to be aligned in a step S600. In a step S610 the measured skewness value is stored as a target skewness value S_{T}. Then, in a step S620, a current skewness value Sc is measured while merging the primary beam component and the secondary beam component during adjusting alignment of the optical module to adjust S_{C} to reduce a difference between S_{C} and S_{T}, i.e., to target the previously stored skewness value.

According to another aspect of an embodiment, the image analysis module may be adapted to store the position of the centroid of one of multiple (e.g., two) far field beam images in a memory, followed by optically blocking the far field beam image for which the position of the centroid has been stored and then moving the centroid of the remaining (unblocked) far field beam image to the centroid position stored in memory. Towards this end, as shown in FIG. 12, the image analysis module 910 may be supplied with a partial image blocker 915 which is arranged to have a first state in which partial image blocker 915 permits passage of multiple (e.g., two) beam images to the image analysis module 910 and a second state in which partial image blocker 915 blocks at least one (e.g., one of two) of the multiple beam images presented to the image analysis module 910.

In operation, the image analysis module 910 measures and stores a value indicative of the position of the centroid of one of the images in the image information from the optical module 900. The image analysis module 910 stores this centroid position value in the memory 930. Then the partial image blocker 915 blocks the image of the beam for which the position of the centroid was measured and stored and then measures the position of the centroid for the other beam image. The controller 920 controls the actuator 905 to cause the position of the centroid for the other beam image to move towards the centroid position stored in the memory 930.

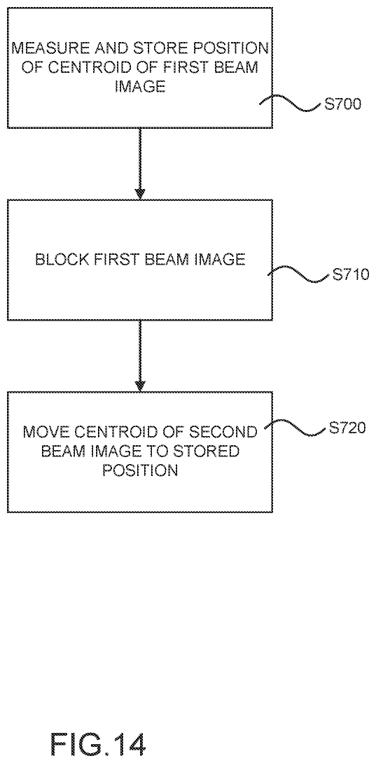

FIG. 14 is a flow chart describing this procedure. A beam image centroid position is measured in a first beam image from an optical module to be aligned and the measured centroid position is stored as a target centroid position value in a step S700. Then, in a step S710 the first beam image is blocked. Then in a step S720 the centroid position of a second beam image is measured while adjusting alignment of the optical module to move the centroid position of the second beam image to the previously stored target centroid position value stored in memory.

These same procedures may be used to align other optical modules in the optical train. For example, some arrangements may have two OPUS modules, specifically, a Vertical Opus and a Horizontal Opus. The procedures described above can be used to align the Vertical OPuS and to align the Horizontal OPuS. Alignment of the Vertical OPuS can be carried out using symmetry overlapping as described above in connection with FIG. 7 or FIGS. 12 and 13. Alignment of the Horizontal OPuS can be carried out using Hough transforms or a Haar cascade classifier to identify beam positions as well as component positions during alignment of the Horizontal OPuS.

According to another aspect of an embodiment, features, e.g., lines and contours in images obtained at one or more alignment ports are detected using a Probabilistic HoughLine Transform (PHT). The PHT is an extension of the standard HoughLine Transform. In the PHT, instead of considering all possible lines in the image, only a random subset of the detected edge points are considered, which makes the PHT more efficient. The PHT works by first detecting edge points in the image using an edge detection procedure such as a Canny edge detector. Then, a random subset of these edge points is selected and used to generate line segments in parameter space using the same representation as in the standard Hough transform. Next, a voting scheme is used to determine which of these line segments correspond to actual lines in the image. This is done by incrementing a count for each point that falls along the line segment in the image. The line segment with the highest count is then considered to be a valid line in the image. Finally, this process is repeated multiple times with different subsets of edge points to increase the accuracy of the line detection.

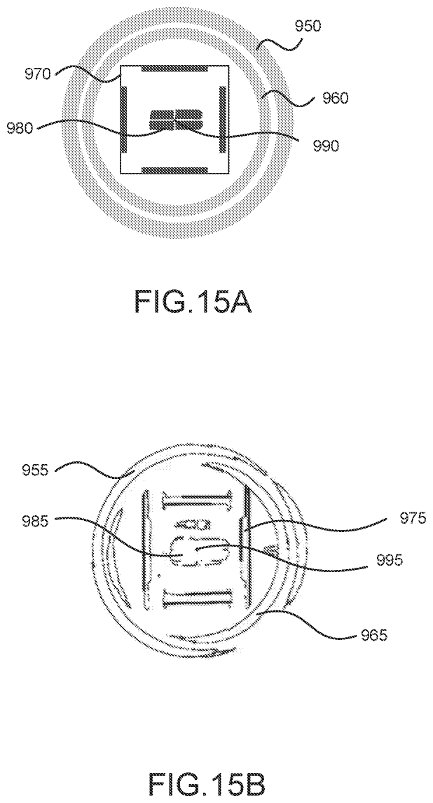

For example, for the alignment ports for the PRA WEB and the BR, the PHT is used to detect the illuminated outside window or frame for the image. From this the center of the window for the target may be determined. FIG. 15A is a representation of a beam image obtained at the alignment port of the BR. The grey scale in the representation may be inverted in the actual image. As can be seen, the image includes reflections 950 and 960 from the aperture edges and an illuminated frame 970. There is also a beam image 980 and crosshairs 990.

The PHT is performed on the image represented in FIG. 15A to identify features in the image. FIG. 15B is a representation of the result of performing a PHT on the image of FIG. 15A. Again, the grey scale in the representation may be inverted in the actual PHT result. As can be seen, the PHT locates the positions 955 and 965 of the edges of the apertures 950 and 960, respectively. The PHT also locates the position 975 of the illuminated frame 970 and the position 985 of the beam image 980 and a center 995 of the illuminated frame 970.

The PHT can be performed by the image analysis module 910 (FIG. 12). The controller 920 (FIG. 12) can use the positions of features in the image as located by the PHT to align the optical module 900 (FIG. 12).

The above description includes examples of multiple embodiments. It is, of course, not possible to describe every conceivable combination of components or methodologies for purposes of describing these embodiments, but one of ordinary skill in the art may recognize that many further combinations and permutations of various embodiments are possible. Accordingly, the described embodiments are intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is construed when employed as a transitional word in a claim. In addition, although elements of the described aspects and/or embodiments may be described or claimed in the singular, the plural is contemplated unless limitation to the singular is explicitly stated. Additionally, all or a portion of any aspect and/or embodiment may be utilized with all or a portion of any other aspect and/or embodiment, unless stated otherwise.

The embodiments can be further described using the following clauses.
1. Apparatus for aligning an optical module to a beam path of a beam in a laser light source, the apparatus comprising:
a beam imager arranged to acquire an image of the beam after the beam has interacted with the optical module;
an image analysis module arranged to receive the image and adapted to make an alignment determination of an alignment state of the optical module with respect to the beam based at least in part on the image and to generate a control signal based on the alignment determination; and
an actuator mechanically coupled to the optical module and arranged to alter the alignment state of the optical module based on the control signal.
2. The apparatus of clause 1 wherein the beam path comprises a power ring amplifier (PRA) alignment path including the optical module.
3. The apparatus of clause 2 wherein the optical module comprises at least one of a master oscillator (MO) wavefront engineering box (WEB), a PRA WEB, a PRA chamber, a beam reverser (BR), and an autoshutter module.
4. The apparatus of clause 3 wherein the optical module comprises the BR and wherein the image is acquired of the beam at the autoshutter module.
5. The apparatus of clause 4 wherein the autoshutter module comprises a combined autoshutter and metrology module.
6. The apparatus of clause 1 wherein the image analysis module is adapted to make the alignment determination based at least in part on detection of at least one edge of an aperture in the optical module.
7. The apparatus of clause 6 wherein the image analysis module is adapted to control the actuator to sweep the beam across the aperture to detect at least one edge of the aperture.
8. The apparatus of clause 6 wherein the image analysis module is adapted to detect the at least one edge of the aperture using a Hough transform.
9. The apparatus of clause 1 wherein the image analysis module is adapted to detect a window and determine a center of the window using an object detecting model.
10. The apparatus of clause 9 wherein the image analysis module is adapted to detect the window and determine a center of the window using a Haar Cascade Classifier.
11. The apparatus of clause 1 wherein the image analysis module is adapted to make the alignment determination of the optical module based at least in part on labeling of one or more contours in the image as one of a primary beam and a secondary beam.
12. The apparatus of clause 11 wherein the image analysis module is adapted to make the alignment determination of the optical module based on at least one primary beam and at least one secondary beam, and to control the actuator to cause the secondary beam and the primary beam to merge to form a merged beam.
13. The apparatus of clause 12 wherein the image analysis module is adapted to control the actuator to increase a symmetry of the merged beam.
14. A method of aligning an optical module to a beam path of a beam in a laser light source, the method comprising:
acquiring an image of the beam after the beam has interacted with the optical module; making an alignment determination of an alignment state of the optical module based at least in part on the image;
generating a control signal based on the alignment determination; and
using the control signal to control an actuator mechanically coupled to the optical module to alter an alignment state of the optical module.
15. The method of clause 14 wherein the beam path comprises a power ring amplifier (PRA) alignment path.
16. The method of clause 14 wherein the optical module comprises one of a master oscillator (MO) wavefront engineering box (WEB), a PRA WEB, a PRA chamber, a beam reverser (BR) and an autoshutter module in the PRA alignment path.
17. The method of clause 16 wherein the optical module comprises the BR and wherein the image is acquired of the beam at the autoshutter module.
18. The method of clause 16 wherein the autoshutter module comprises a combined autoshutter and metrology module.
19. The method of clause 14 wherein making an alignment determination of an alignment state of the optical module comprises detecting at least one edge of an aperture in the optical module.
20. The method of clause 19 further comprising controlling the actuator to sweep the beam across the aperture to detect the at least one edge of the aperture.
21. The method of clause 19 wherein detecting at least one edge of an aperture in the optical module comprises using a Hough transform.
22. The method of clause 14 wherein making an alignment determination of an alignment state of the optical module based at least in part on the image is performed using an image analysis module adapted to detect an aperture or an illuminated surface and determine a center and size of an object using an object detecting model.
23. The method of clause 22 wherein using an image analysis module adapted to detect an aperture or an illuminated surface and determine a center and size of an object an object detecting model comprises using a Haar Cascade Classifier.
24. The method of clause 14 wherein making an alignment determination of an alignment state of the optical module comprises labeling of one or more contours in the image as one of a primary beam and a secondary beam.
25. The method of clause 24 wherein labeling of one or more contours in the image as one of a primary beam and a secondary beam comprises labeling of at least one contour in the image as a primary beam and at least one contour in the image as a secondary beam and further comprising merging the primary beam and the secondary beam to form a merged beam.
26. The method of clause 25 further comprising increasing a symmetry of the merged beam.
27. Apparatus for aligning an optical module to a beam path of a beam in a laser light source, the apparatus comprising:
a memory;
a beam imager arranged to acquire an image of the beam after the beam has interacted with the optical module;
an image analysis module arranged to receive the image, to measure one or more beam characteristics from the image, and to store information indicative of the one or more beam characteristics in the memory;
a controller adapted to generate a control signal based on the one or more beam characteristics; and an actuator mechanically coupled to the optical module and arranged to alter an alignment state of the optical module based on the control signal,
wherein the image analysis module is further arranged to make a subsequent measurement of the one or more beam characteristics from the image and the controller is arranged to generate the control signal to control the actuator to reduce a difference between the one or more beam characteristics as measured by the subsequent measurement and the stored information.
28. The apparatus of clause 27 wherein the beam characteristic is beam skewness, the information indicative of the one or more beam characteristics is a target beam skewness and wherein the image analysis module is further arranged to make a subsequent measurement of the beam skewness and the controller is arranged to generate the control signal to control the actuator to reduce a difference between the subsequent measurement of the beam skewness and the target beam skewness.
29. The apparatus of clause 27 wherein the beam characteristic is a measured position of a centroid of an image of one of a primary beam component and a secondary beam component of the beam, the information indicative of the one or more beam characteristics is the measured position of the centroid and wherein the image analysis module is further arranged to make a subsequent measurement of a position of a centroid of the other of the primary beam component and the secondary beam component and the controller is arranged to generate the control signal to control the actuator to move the position of the centroid of the other of the primary beam component and the secondary beam component to the measured position stored in the memory.
30. The apparatus of clause 29 further comprising a beam component blocking element arranged to block the one of the first beam component and the second beam component when the image analysis module is measuring the position of the centroid of the other of the first beam component and the second beam component.
31. A method of aligning an optical module to a beam path of a beam in a laser light source, the method comprising:
acquiring an image of the beam after the beam has interacted with the optical module;
measuring one or more beam characteristics from the image;
storing information indicative of the one or more beam characteristics in a memory;
generating a control signal based on the one or more beam characteristics;
actuating an actuator mechanically coupled to the optical module and arranged to alter an alignment state of the optical module based on the control signal;
making a subsequent measurement of the one or more beam characteristics; and
generating the control signal to control the actuator to reduce a difference between the one or more beam characteristics as measured by the subsequent measurement and the stored information.
32. The method of clause 31 wherein the beam characteristic is beam skewness, the information indicative of the one or more beam characteristics is a target beam skewness, making a subsequent measurement of the one or more beam characteristics comprises making a subsequent measurement of the beam skewness, and generating the control signal comprises generating the control signal to control the actuator to reduce a difference between the subsequent measurement of the beam skewness and the target beam skewness.
33. The method of clause 31 wherein the beam characteristic is a measured position of a centroid of an image of one of a primary beam component and a secondary beam component of the beam, the information indicative of the one or more beam characteristics is the measured position of the centroid and wherein making a subsequent measurement of the one or more beam characteristics comprises making a subsequent measurement of a position of a centroid of the other of the primary beam component and the secondary beam component and generating the control signal to comprises generating the signal to control the actuator to move the position of the centroid of the other of the primary beam component and the secondary beam component to the measured position stored in the memory.
34. The method of clause 33 further comprising blocking the one of the first beam component and the second beam component during measuring the position of the centroid of the other of the first beam component and the second beam component.
35. Apparatus for aligning an optical module to a beam path of a beam in a laser light source, the apparatus comprising:
a beam imager arranged to acquire an image of the beam after the beam has interacted with the optical module;
an image analysis module arranged to receive the image and to perform a Probabilistic HoughLine Transform to locate a position of one or more features in the image;
a controller adapted to generate a control signal based on the one or more features located in the image; and
an actuator mechanically coupled to the optical module and arranged to alter an alignment state of the optical module based on the control signal.
36. The apparatus of clause 35 wherein the one or more features located in the image includes an illuminated frame in the image.
37. The apparatus of clause 35 wherein the one or more features located in the image includes a position of a center of the illuminated frame.
38. A method of aligning an optical module to a beam path of a beam in a laser light source, the method comprising:
acquiring an image of the beam after the beam has interacted with the optical module;
performing a Probabilistic HoughLine Transform to locate a position of one or more features in the image;
generating a control signal based on the one or more features located in the image; and
altering an alignment state of the optical module based on the control signal.
39. The method of clause 38 wherein the one or more features located in the image includes an illuminated frame in the image.
40. The method of clause 38 wherein the one or more features located in the image includes a position of a center of the illuminated frame.

The above described implementations and other implementations are within the scope of the following claims.

1. Apparatus for aligning an optical module to a beam path of a beam in a laser light source, the apparatus comprising:
a beam imager arranged to acquire an image of the beam after the beam has interacted with the optical module;
an image analysis module arranged to receive the image and adapted to make an alignment determination of an alignment state of the optical module with respect to the beam based at least in part on the image and to generate a control signal based on the alignment determination; and
an actuator mechanically coupled to the optical module and arranged to alter the alignment state of the optical module based on the control signal.

2. The apparatus of claim 1 wherein the beam path comprises a power ring amplifier (PRA) alignment path including the optical module.

3. The apparatus of claim 2 wherein the optical module comprises at least one of a master oscillator (MO) wavefront engineering box (WEB), a PRA WEB, a PRA chamber, a beam reverser (BR), and an autoshutter module.

4. The apparatus of claim 3 wherein the optical module comprises the BR and wherein the image is acquired of the beam at the autoshutter module.

5. The apparatus of claim 4 wherein the autoshutter module comprises a combined autoshutter and metrology module.

6. The apparatus of claim 1 wherein the image analysis module is adapted to make the alignment determination based at least in part on detection of at least one edge of an aperture in the optical module.

7. The apparatus of claim 6 wherein the image analysis module is adapted to control the actuator to sweep the beam across the aperture to detect at least one edge of the aperture.

8. The apparatus of claim 6 wherein the image analysis module is adapted to detect the at least one edge of the aperture using a Hough transform.

9. The apparatus of claim 1 wherein the image analysis module is adapted to detect a window and determine a center of the window using an object detecting model.

10. The apparatus of claim 9 wherein the image analysis module is adapted to detect the window and determine a center of the window using a Haar Cascade Classifier.

11. The apparatus of claim 1 wherein the image analysis module is adapted to make the alignment determination of the optical module based at least in part on labeling of one or more contours in the image as one of a primary beam and a secondary beam.

12. The apparatus of claim 11 wherein the image analysis module is adapted to make the alignment determination of the optical module based on at least one primary beam and at least one secondary beam, and to control the actuator to cause the secondary beam and the primary beam to merge to form a merged beam.

13. The apparatus of claim 12 wherein the image analysis module is adapted to control the actuator to increase a symmetry of the merged beam.

14. A method of aligning an optical module to a beam path of a beam in a laser light source, the method comprising:
acquiring an image of the beam after the beam has interacted with the optical module;
making an alignment determination of an alignment state of the optical module based at least in part on the image;
generating a control signal based on the alignment determination; and
using the control signal to control an actuator mechanically coupled to the optical module to alter an alignment state of the optical module.

15. (canceled)

16. The method of claim 14 wherein the optical module comprises one of a master oscillator (MO) wavefront engineering box (WEB), a PRA WEB, a PRA chamber, a beam reverser (BR) and an autoshutter module in the PRA alignment path.

17. The method of claim 16 wherein the optical module comprises the BR and wherein the image is acquired of the beam at the autoshutter module.

18-21. (canceled)

22. The method of claim 14 wherein making an alignment determination of an alignment state of the optical module based at least in part on the image is performed using an image analysis module adapted to detect an aperture or an illuminated surface and determine a center and size of an object using an object detecting model.

23-26. (canceled)

27. Apparatus for aligning an optical module to a beam path of a beam in a laser light source, the apparatus comprising:
a memory;
a beam imager arranged to acquire an image of the beam after the beam has interacted with the optical module;
an image analysis module arranged to receive the image, to measure one or more beam characteristics from the image, and to store information indicative of the one or more beam characteristics in the memory;
a controller adapted to generate a control signal based on the one or more beam characteristics; and
an actuator mechanically coupled to the optical module and arranged to alter an alignment state of the optical module based on the control signal,
wherein the image analysis module is further arranged to make a subsequent measurement of the one or more beam characteristics from the image and the controller is arranged to generate the control signal to control the actuator to reduce a difference between the one or more beam characteristics as measured by the subsequent measurement and the stored information.

28. The apparatus of claim 27 wherein the beam characteristic is beam skewness, the information indicative of the one or more beam characteristics is a target beam skewness and wherein the image analysis module is further arranged to make a subsequent measurement of the beam skewness and the controller is arranged to generate the control signal to control the actuator to reduce a difference between the subsequent measurement of the beam skewness and the target beam skewness.

29. The apparatus of claim 27 wherein the beam characteristic is a measured position of a centroid of an image of one of a primary beam component and a secondary beam component of the beam, the information indicative of the one or more beam characteristics is the measured position of the centroid and wherein the image analysis module is further arranged to make a subsequent measurement of a position of a centroid of the other of the primary beam component and the secondary beam component and the controller is arranged to generate the control signal to control the actuator to move the position of the centroid of the other of the primary beam component and the secondary beam component to the measured position stored in the memory.

30. The apparatus of claim 29 further comprising a beam component blocking element arranged to block the one of the first beam component and the second beam component when the image analysis module is measuring the position of the centroid of the other of the first beam component and the second beam component.

31. A method of aligning an optical module to a beam path of a beam in a laser light source, the method comprising:
acquiring an image of the beam after the beam has interacted with the optical module;
measuring one or more beam characteristics from the image;
storing information indicative of the one or more beam characteristics in a memory;
generating a control signal based on the one or more beam characteristics;
actuating an actuator mechanically coupled to the optical module and arranged to alter an alignment state of the optical module based on the control signal;
making a subsequent measurement of the one or more beam characteristics; and
generating the control signal to control the actuator to reduce a difference between the one or more beam characteristics as measured by the subsequent measurement and the stored information.

32. (canceled)

33. The method of claim 31 wherein the beam characteristic is a measured position of a centroid of an image of one of a primary beam component and a secondary beam component of the beam, the information indicative of the one or more beam characteristics is the measured position of the centroid and wherein making a subsequent measurement of the one or more beam characteristics comprises making a subsequent measurement of a position of a centroid of the other of the primary beam component and the secondary beam component and generating the control signal to comprises generating the signal to control the actuator to move the position of the centroid of the other of the primary beam component and the secondary beam component to the measured position stored in the memory, the method further comprising blocking the one of the first beam component and the second beam component during measuring the position of the centroid of the other of the first beam component and the second beam component.

34. (canceled)

35. Apparatus for aligning an optical module to a beam path of a beam in a laser light source, the apparatus comprising:
a beam imager arranged to acquire an image of the beam after the beam has interacted with the optical module;
an image analysis module arranged to receive the image and to perform a Probabilistic HoughLine Transform to locate a position of one or more features in the image;
a controller adapted to generate a control signal based on the one or more features located in the image; and
an actuator mechanically coupled to the optical module and arranged to alter an alignment state of the optical module based on the control signal.

36. The apparatus of claim 35 wherein the one or more features located in the image includes an illuminated frame in the image.

37. The apparatus of claim 35 wherein the one or more features located in the image includes a position of a center of the illuminated frame.

38. A method of aligning an optical module to a beam path of a beam in a laser light source, the method comprising:
acquiring an image of the beam after the beam has interacted with the optical module;
performing a Probabilistic HoughLine Transform to locate a position of one or more features in the image;
generating a control signal based on the one or more features located in the image; and
altering an alignment state of the optical module based on the control signal.

39-40. (canceled)
